(19) United States
(12) Patent Application Publication
(10) Pub. No.: US 2026/0181610 A1
(43) Pub. Date: Jun. 25, 2026

(54) MEASUREMENT CAPABILITY AND CONFIGURATION ON SHARED SPECTRUM FOR TERRESTRIAL AND NON-TERRESTRIAL NETWORKS

(71) Applicant: Apple Inc., Cupertino, CA (US)

(72) Inventors: Jie Cui, San Jose, CA (US); Yang Tang, San Jose, CA (US); Qiming Li, Beijing (CN); Dawei Zhang, Saratoga, CA (US); Haitong Sun, Cupertino, CA (US); Chunxuan Ye, San Diego, CA (US)

(21) Appl. No.: 18/848,070

(22) PCT Filed: Sep. 27, 2023
(86) PCT No.: PCT/CN2023/121944

§ 371 Date: Sep. 17, 2024

(30) Foreign Application Priority Data
Sep. 27, 2023 (WO) PCT/CN2023/121944

(51) Int. Cl. H04W 72/0453; H04L 5/00; H04W 24/10; H04W 36/08; H04W 72/51; H04W 84/06

(52) U.S. Cl. CPC H04W 72/0453; H04L 5/0051; H04W 24/10; H04W 36/08; H04W 72/51; H04W 84/06

(57) ABSTRACT

Wireless communication systems, including systems, apparatuses, and methods for measurement capability and configuration on shared spectrum terrestrial networks (TNs) and non-terrestrial networks (NTNs) are disclosed. A user equipment (UE) includes a transceiver and a processor configured to cause the UE to receive, via the transceiver, control signaling indicating a neighbor cell measurement configuration for a radio frequency (RF) spectrum band utilized by both a TN device and an NTN device to serve UEs. The processor is further configured to receive, via the transceiver and according to the indicated neighbor cell measurement configuration, reference signals of the RF spectrum band from the TN device and from the NTN device. The processor is further configured to perform a mobility operation based on the reference signals from the TN device, the reference signals received from the NTN device, or both.

### TECHNICAL FIELD

This application relates generally to wireless communication systems, including systems, apparatuses, and methods for measurement capability and configuration on shared spectrum terrestrial and non-terrestrial networks.

### BACKGROUND

Wireless mobile communication technology uses various standards and protocols to transmit data between a network device (e.g., a base station, a radio head, etc.) and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a network device of the RAN (which may also sometimes be referred to generally as a RAN node, a network node, or simply a node) and a wireless communication device known as a UE. 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the network device and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A network device used by a RAN may correspond to that RAN. One example of an E-UTRAN network device is an Evolved Universal Terrestrial Radio Access Network (E-UTRAN) Node B (also commonly denoted as evolved Node B, enhanced Node B, eNodeB, or eNB). One example of an NG-RAN network device is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIG. 2 shows an example wireless communications system, according to one or more aspects described herein.

FIG. 3 shows an example wireless communications system, according to one or more aspects described herein.

FIG. 4 shows an example method of wireless communication at a user equipment (UE), according to one or more aspects described herein.

FIG. 5 shows an example method of wireless communication at a network device, according to one or more aspects described herein.

FIG. 6 illustrates an example architecture of a wireless communication system, according to embodiments described herein.

FIG. 7 illustrates an example system for performing signaling between a wireless device and a network device, according to embodiments described herein.

### DETAILED DESCRIPTION

Various embodiments are described with regard to a user equipment (UE), a non-terrestrial network (NTN) device, a network device (e.g., a terrestrial network (TN) device). However, reference to a UE is merely provided for illustrative purposes. The example embodiments may be utilized with any electronic component that may establish a connection to a network and is configured with the hardware, software, and/or firmware to exchange information and data with a network. Therefore, the UE, the NTN device, and the network device as described herein is used to represent any appropriate electronic device.

Terrestrial cellular networks are typically deployed to segregate different portions of radio frequency (RF) spectrum into different geographic coverage areas, for example to avoid interference in neighboring coverage areas. Network devices (e.g., a base station or gNodeB (gNB)) use a portion of the RF spectrum in a set or configured coverage area, and the network devices are geographically stationary. However, a UE in some geographic areas may not have coverage from a network device, for example due to the area being remote from any network devices, or blocked from communicating with a network device by mountains, buildings, or other obstacles.

NTN devices, or other network devices operating above the surface of the earth, can provide communication resources to UEs (e.g., terrestrial, airborne, or on water) with a particular coverage area served by the NTN device. An appropriately configured UE that lacks coverage from a TN device may instead communicate with an NTN device. In some deployments, NTN devices are stationary relative to features on the ground, but other NTN devices move relative to the ground. Examples of stationary NTN devices include satellites in geosynchronous orbit (GSO or GEO). Examples of moving or NTN devices includes include satellites in low earth orbit (LEO) or medium earth orbit (MEO), satellites in a polar orbit, high-altitude platforms (HAPS), or drones. UEs may operate on the surface of the earth, but may also operate above the surface or on water, for example on or as part of an aircraft or ship.

Cellular network operators typically have a license to operate in a particular RF spectrum band, and may deploy a network that uses both TN devices and NTN devices. As such, it may be desirable to reuse spectrum for NTN devices that is already being used for TN devices, for example to maximize use of the spectrum. While segregating coverage areas using a particular bandwidth of RF spectrum between TN device may be relatively straightforward because the TN devices are stationary, reusing one or more portions of the RF spectrum (e.g., bands, carriers) for NTN devices may present additional challenges. For example, because at least some of the NTN devices may be mobile, and thus their corresponding coverage areas (cells) are mobile, a UE may see (observe, measure, or otherwise communicate signals with) both NTN cells and TN cells on the same portion of the RF spectrum when such spectrum is used by both TN cells (or NTN cells) that are stationary and NTN cells that are mobile. In light of the above, techniques that allow for the efficient (e.g., increased or maximized) use of RF spectrum between stationary (e.g., TN cells) and moving (e.g., NTN cells).

Systems, apparatuses, and methods for measurement capability and configuration on shared (e.g., reused) spectrum terrestrial and non-terrestrial networks are disclosed. In one or more embodiments, in networks having both TN cells and NTN cells, one or more RF spectrum bands are utilized by both a TN device and an NTN device (which may also be referred to as the RF spectrum band being “shared” or “reused” herein). A UE then receives control signaling indicating a neighbor cell measurement configuration (e.g., a synchronization signal block (SSB)-based radio resource management (RRM) measurement timing configuration (SMTC)), indicating to the UE that the RF spectrum bands are shared. The UE may then use the configuration to monitor for (listen, be configured to receive) and receive references signals (e.g., SSBs or portions of SSBs) from neighboring network devices, including NTN devices and TN devices, when such devices are present. Based on the received reference signals (e.g., measurements performed on such reference signals), the UE can then perform a mobility operation.

On the network side, in one or more embodiments, a UE provides UE capability signaling to the network device indicating that the UE support NTN SSB-based RRM measurements. In response (e.g., directly or indirectly), the network device then transmits to the UE (e.g., directly or indirectly via an NTN device) control signaling that indicates a neighbor cell measurement configuration for the UE for the RF spectrum band that is utilized by both a TN device and an NTN device to serve UEs. Having configured the UE, the network can then coordinate the coverage for the shared RF spectrum band to minimize or eliminate coverage overlap of NTN cells with TN cells.

The techniques described herein can allow for successful (e.g., more efficient) coexistence of mobile NTN devices with TN devices in a deployment while increasing or maximizing RF spectrum utilization for the network operator. In one or more embodiments, overlapped coverage areas for shared RF spectrum can be managed.

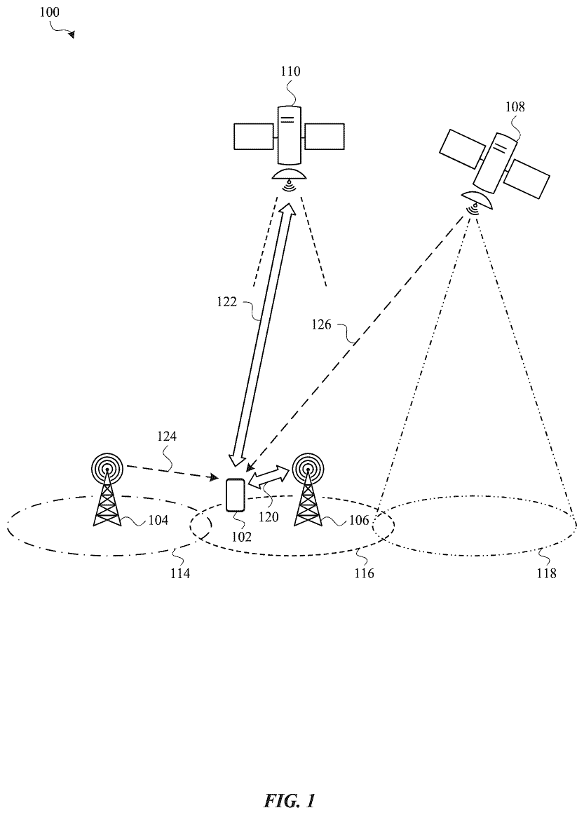

FIG. 1 shows an example wireless communications system 100, according to one or more aspects described herein. Wireless communications system 100 supports one or more aspects of measurement capability and configuration on shared spectrum TN and NTN, as further described herein.

Wireless communications system 100 includes one or more UEs 102 that may be being served by (e.g., has an established radio resource control (RRC) connection with) a TN device 106 via communication link 120 or an NTN device 110 via communication link 122. Coverage area 116 (e.g., a cell or serving cell) is the service area for the RF spectrum band utilized by TN device 106 or NTN device 110 serving the UE 102.

To support UE mobility (e.g., via RRM) as a UE moves relative to coverage areas of the network, network devices transmit reference signals that can be monitored for (e.g., listened for), received by, and measured by UEs. In one or more embodiments, the reference signals are SSBs. Wireless communications system 100 includes, for UE 102, a neighboring TN device 104 having a corresponding neighbor cell corresponding to a coverage area 114. The neighboring TN device 104 transmits reference signals 124 (e.g., SSBs) in support of RRM (e.g., among other purposes and uses). Wireless communications system 100 further includes, for UE 102, an NIN device 108 that is a neighboring NTN device, having a corresponding neighbor cell corresponding to a coverage area 118. Similar to TN device 104, the NTN device 108 that is a neighboring NTN device transmits reference signals 126 (e.g., SSBs) in support of RRM (e.g., among other purposes and uses).

In one or more embodiments, the UE 102 is a device that is capable of supporting NTN reference signal measurements (e.g., NTN SSB-based RRM measurements). In some embodiments, upon establishing an RRC connection with the network, the UE 102 provides UE capability signaling to the network (e.g., via RRC signaling). As part of such UE capability signaling, the UE can provide, to the network, an indication that the UE supports NTN SSB-based RRM measurements. In some embodiments, the UE capability signaling providing such indication is part of or associated with a parameter of an information element associated with SMTC configuration (e.g., parallelSMTC). According to one or more embodiments, the UE 102 provides an indication (e.g., explicitly via a parameter or filed value or one or more bits, or implicitly) in the capability signaling that the indication is associated with one of NTN only, TN only, or both NTN and TN.

In some embodiments, the control signal (e.g., as part of or inside parallelSMTC) UE 102 can indicate how many (e.g., via an indication of quantity or a range of quantities) SMTCs that UE 102 can support. In one or more embodiments, the value or quantity depends on the context to which it is applied. That is, in some embodiments, if the indication of capability is for NTN only, then the indication of quantity is understood by both UE 102 and the network to indicate the quantity (number) of SMTC-NIN, and if UE 102 indicates that the indication of capability is for both NTN and TN, then the indication of quantity is understood by both UE 102 and the network to indicate the total number of SMTC-NTN and SMTC-TN that UE can support on one carrier (e.g. the shared RF spectrum band).

In one or more embodiments, the UE capability signaling providing an indication that the UE supports NTN SSB-based RRM measurements is part of or associated with a parameter of an information element associated with SMTC configuration that also indicates the total number of SMTC-NTN and SMTC-TN that the UE 102 can support on a single carrier (e.g., the shared RF spectrum band), In some embodiments this UE capability signaling may be a parameter (e.g., parallelSMTC-NTNandTN) that is different from a parameter indicating that the UE supports NTN SSB-based RRM measurements (e.g., parallelSMTC).

In one or more embodiments, the SMTC-NTN (e.g., for measurement of reference signals 124 from TN device 104) and SMTC-TN (e.g., for measurement of reference signals 126 from NTN device 108) may collide in the time domain. In some embodiments a collision in time may occur when one or more time resources for the SMTC-NTN overlap at least in part with one or more time resources for the SMTC-TN. In some embodiments, a collision in time occurs when the time resources for the SMTC-NTN overlap in full the time resources for the SMTC-NTN, or vice versa. In some embodiments a collision in time may occur when the one or more time resources for the SMTC-NTN are within a threshold time (e.g., number of slots, minislots, symbols, frames, subframes, etc.) of one or more time resources for the SMTC-TN. In some embodiments, the UE 102 may be configured to prioritize the SMTC-TN over the SMTC-NTN for measurement when a collision occurs. In other embodiments, the UE 102 may be configured to prioritize the SMTC-NTN over the SMTC-TN for measurement when a collision occurs. In yet other embodiments, the network provides an indication to the UE 102 (e.g., via configuration signaling, such as RRC signaling, or via other control signaling such as a MAC CE or DCI) indicating for the UE 102 to prioritize one of the SMTC-NTN or the SMTC-TN. In other embodiments, a weighting factor is applied by the UE 102 to determine which of the SMTC-NTN or the SMTC-TN to prioritize during a given time interval. For example, a weighting factor may be ⅓, meaning that every three overlapped SMTCs, the UE 102 uses the SMTC for NTN measurement (e.g., the SMTC is SMTC-NTN), but for the remaining two overlapped SMTC, the UE 102 uses the SMTC for TN measurement (e.g., the SMTC is SMTC-TN).

In one or more embodiments, the UE 102 receives control signaling indicating a neighbor cell measurement configuration (e.g., SMTC) for the shared RF spectrum band utilized by both the NTN device 108 and TN device 104. In one or more embodiments, the UE 102 receives the control signaling (e.g., the indication of the neighbor cell measurement configuration for the UE 102) responsive to the indication of the capability that the UE 102 transmitted to the network.

In one or more embodiments, the network deploys NTN and TN cells on a same frequency carrier (same RF spectrum band), and the network desires to avoid having the NTN device cell coverage area (e.g., overlap at least a portion of) the TN device cell coverage area. In some embodiments, the configuration of the UE 102 by the network may include an indication, for the frequency carrier, to use measure the cell of the TN device, NTN device, or both. In some embodiments, the same frequency carrier may be configured in both measurement occasions or configurations for the TN device and the NTN device. In some embodiments, and as further discussed herein, the UE 102 can avoid monitoring multiple SMTCs for measurement (e.g., avoiding monitoring both SMTC-NIN and SMTC-TN) for the frequency carrier.

In one or more embodiments, the network deploys NTN and TN cells on a same frequency carrier (same RF spectrum band), and the network allows coexistence or overlapping of coverage between the NTN device cell coverage area (e.g., overlap at least a portion of) the TN device cell coverage area. In one or more embodiments, the network configures the UE 102 with SMTCs and/or measurement gaps to allow for NTN cell and TN cell coexistence, in addition to supporting NTN cell communications. In some embodiments, UT 102 monitors both SMTC-NTN and SMTC-TN for mobility purposes.

In one or more embodiments, the network may configure the UE 102 to monitor only certain SMTC types for RRM measurement. In some embodiments, the UE 102 ignores SMTC-NIN (e.g., SMTC associated with or for NTN devices such as NTN device 108), and uses SMTC-TN (e.g., SMTC associated with or for TN devices such as TN device 104), in areas where coverage overlaps (e.g., the intersection between coverage area 116 and coverage area 118, or the intersection between coverage area 116 and coverage area 114).

In some embodiments, the neighbor cell measurement configuration includes an indicator (e.g., flag) indicating whether each SMTC is for TN or NTN or both. In some embodiments, the UE 102 monitors both SMTC-NTNs and SMTC-TNs for mobility purposes (e.g., for RRM operations).

In one or more embodiments, the network provides an indication to the UE 102 of a frequency carrier configuration (e.g., for the shared RF spectrum band) that indicates that the carrier is for both TN and NTN. In some embodiments, the neighbor cell measurement configuration is or includes the frequency carrier configuration.

In one or more embodiments, the network provides a configuration to the UE 102 for NTN measurement objects and a configuration to the UE 102 for TN measurement objects. In some embodiments, the network may configurate the same frequency carrier (e.g., the shared RF spectrum band) in both measurement object configurations, and thereby indicate that the frequency carrier is for both TN and NTN.

In one or more embodiments, the network provides a measurement configuration to the UE 102 for NTN measurements and a measurement configuration to the UE 102 for TN measurements. In some embodiments, the network may configurate the same frequency carrier (e.g., the shared RF spectrum band) in both measurement configurations, and thereby indicate that the frequency carrier is for both TN and NTN.

In one or more embodiments, the network can configure the UE 102 with a SMTC associated with TN devices and NTN devices separately. In some embodiments, the network configures the UE 102 with SMTCs, and provides an indication for each SMTC of whether the SMTC is associated with NTN devices (e.g., SMTC-NTN for NTN measurement), associated with TN devices (e.g., SMTC-TN for TN measurement), or both.

In one or more embodiments, the network provides a measurement configuration to the UE 102 for NTN measurements and a measurement configuration to the UE 102 for TN measurements. In some embodiments, the network may configurate the same frequency carrier (e.g., the shared RF spectrum band) in both measurement configurations, and thereby indicate that the frequency carrier is for both TN and NTN.

In one or more embodiments, the network provides a configuration of measurement objectives for NTN to the UE 102, and a separate configuration of measurement objectives for NTN to the UE 102, for a same frequency carrier. The configuration of measurement objectives for NTN includes a SMTC list for NTN, and the configuration of measurement objectives for TN includes a SMTC list for TN. In some embodiments, one or more SMTCs for NTN may indicate time resources that collide with time resources indicated by one or more SMTCs for TN.

In some embodiments, the shared RF spectrum band may be used by TN device 106, NTN device 110, or both. In one or more embodiments, the control signaling may be RRC signaling that configures RRM at the UE 102, and may be sent to the UE 102 by or via one of TN device 104, TN device 106, NTN device 108, or NTN device 110, or from a different network device that is not shown. Although two neighboring network devices (TN device 104 and NTN device 108) are shown, any number of additional neighboring network devices may be configured for measurement by the network, and measured by the UE 102 as potential or candidate target cells of a RRM operation, consistent with the techniques described herein.

In one or more embodiments, the UE 102 uses the neighbor cell measurement configuration received from the network device to receive reference signals from neighboring network devices on the shared RF spectrum, including a first one or more reference signals (e.g., reference signals 124) from the TN device 104 and a second one or more reference signals (e.g., reference signals 126) from the NTN device 108. The UE 102 may perform a mobility operation (e.g., a RRM operation) based at least in part on the first one or more reference signals received from the terrestrial network device, or the second one or more reference signals received from the non-terrestrial network device, or both.

In one or more embodiments, a network operator operating the wireless communications system 100 can avoid NTN devices using a same carrier frequency (e.g., a shared RF spectrum band) from serving a cell coverage area already served by a TN device. In one or more embodiments, the network can coordinate the NTN device 108 to turn off that carrier frequency (e.g., the shared RF spectrum band) when the NTN device 108 approaches the site of the TN device 106. In other embodiments, the network can coordinate the NTN device 108 to turn off that carrier frequency (e.g., the shared RF spectrum band) when the coverage area 118 of the NTN device 108 approaches the coverage area 116 of the TN device 106.

In some embodiments, a network operator operating the wireless communications system 100 desires to avoid the cell of NTN device 108 to cover the cell of the TN device 104, for example to avoid coverage overlapping between TN and NTN. In such case, in one or more embodiments, the UE 102 monitors only one type of SMTC for RRM measurement (e.g., SMTC-NTN or SMTC-TN) if the network configures the UE 102 with two SMTC lists applicable to NTN devices and TN device on the same frequency carrier. In some embodiments, UE 102 ignores SMTC-NIN (e.g., SMTC-TN over SMTC-NTN, such as prioritizing monitoring resources indicated by SMTC-TN over resources indicated by SMTC-NTN) in the overlapped coverage area (e.g., where coverage area 116 and coverage area 118 overlap). Otherwise, UE 102 monitors (e.g., prioritizes) SMTC-NTN instead of SMTC-TN in coverage area 118, that is an NTN-only coverage area.

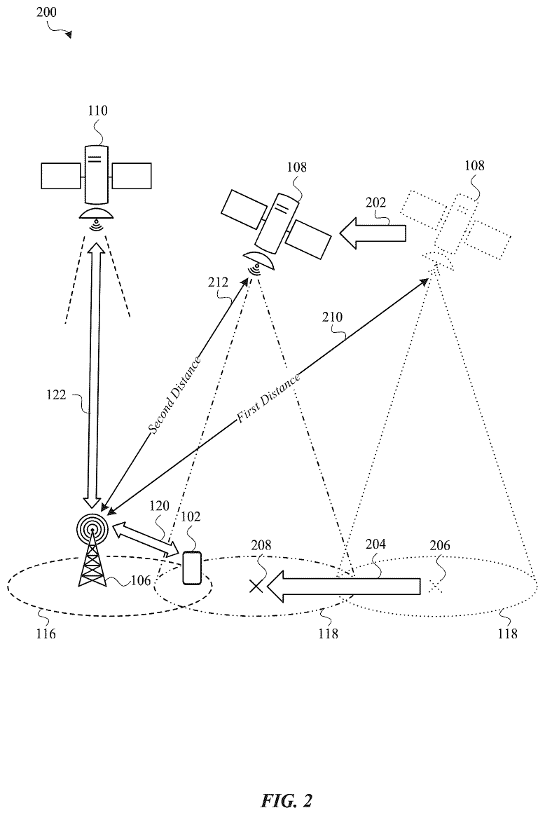

FIG. 2 shows an example wireless communications system 200, according to one or more aspects described herein. Wireless communications system 200 supports one or more aspects of measurement capability and configuration on shared spectrum TN and NTN, as further described herein.

Wireless communications system 200 includes one or more UEs 102 that may be being served by (e.g., has an established radio resource control (RRC) connection with) a TN device 106 via communication link 120. Additionally or alternatively, UE 102 may be served by an NTN device, such as an NTN device 110 via communication link 122. Coverage area 116 (e.g., a cell or serving cell) is the service area for the RF spectrum band utilized by TN device 106 or NTN device 110.

In one or more embodiments, a network operator operating the wireless communications system 200 can avoid NTN devices using a same carrier frequency (e.g., a shared RF spectrum band) from serving a cell coverage area already served by a TN device. In such case, the network can coordinate an NTN device to turn off that carrier frequency (e.g., the shared RF spectrum band) when the NTN device approaches the site of a TN device.

In one or more embodiments, the NTN device 108 that is a neighboring NTN device has a corresponding neighbor cell corresponding to a coverage area 118, the center of which is position 206. At a first time, the distance from the NTN device 108 to UE 102 is a first distance 210. As NTN device 108 moves an orbiting distance 202, the center of the coverage area 118 moves distance 204 and becomes position 208, and the distance from the NTN device 108 to UE 102 is a second distance 212.

In one or more embodiments, the network coordinates with the NTN device 108 so that the NTN device 108 turns off (e.g., disables, ceases transmitting) on the shared frequency carrier (e.g., the shared RF spectrum band) once the distance between the TN device 106 and NTN device 108 is less than or equal to a threshold distance. As shown for wireless communications system 200, the first distance 210 meets or exceeds the distance threshold, and NTN device 108 transmits on the shared carrier frequency (e.g., serving UEs in coverage area 118). However, the second distance 212 is less than or equal to the distance threshold, and NTN device 108 no longer transmits on the shared carrier frequency.

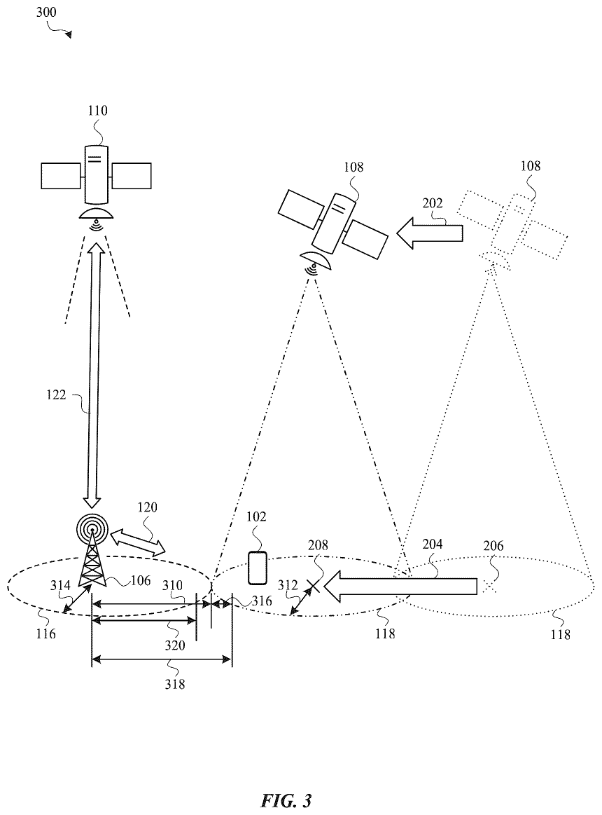

FIG. 3 shows an example wireless communications system 300, according to one or more aspects described herein. Wireless communications system 300 supports one or more aspects of measurement capability and configuration on shared spectrum TN and NTN, as further described herein.

Wireless communications system 300 includes one or more UEs 102 that may be being served by a TN device 106 via communication link 120. Additionally or alternatively, UE 102 may be served by an NIN device, such as an NIN device 110 via communication link 122. Coverage area 116 (e.g., a cell or serving cell) is the service area for the RF spectrum band utilized by TN device 106 or NTN device 110.

In one or more embodiments, a network operator operating the wireless communications system 300 can avoid NTN devices using a same carrier frequency (e.g., a shared RF spectrum band) from serving a cell coverage area already served by a TN device. In such case, the network can coordinate an NTN device to turn off that carrier frequency (e.g., the shared RF spectrum band) when the NTN device approaches the site of a TN device.

In one or more embodiments, the NTN device 108 has a corresponding neighbor cell corresponding to a coverage area 118, the center of which is position 206. As NIN device 108 moves an orbiting distance 202, the center of the coverage area 118 moves distance 204 and becomes position 208. The coverage area 116 of TN device 106 has a radius 314, and the coverage area 118 of NTN device 108 has a radius 312, Coverage area 116 and coverage area 118 are shown as substantially regular, but may be various shapes (e.g., having different radius or distance from the center in different directions), for example due to terrain, buildings, or other varied features in which the TN device 106 and the NTN device 108 are deployed. In one or more embodiments, the coverage area may be a simple calculation of center location of the site of a TN device and the radius of coverage.

In one or more embodiments, the network coordinates with the NTN device 108 so that the NTN device 108 turns off (e.g., disables, ceases transmitting) on the shared frequency carrier (e.g., the shared RF spectrum band) once the distance 310 between the coverage area 116 and coverage area 118 is less than or equal to a threshold distance. As shown for wireless communications system 300, if the distance 310 meets or exceeds the threshold distance, the NTN device 108 transmits on the shared carrier frequency (e.g., serving UEs in coverage area 118). However, if the distance 310 is less than or equal to the threshold distance, NTN device 108 no longer transmits on the shared carrier frequency.

In some embodiments, the threshold distance is equal to the radius 314 of the coverage area 116. In some embodiments, the threshold distance may include a margin 316 that is in addition to the radius 314, threshold distance being threshold distance 318. In yet other embodiments, the threshold distance is less than the radius 314, the threshold distance being threshold distance 320. In yet other embodiments, different threshold distances are used in different directions, or based on whether the network is turning off the frequency carrier or turning on the frequency carrier.

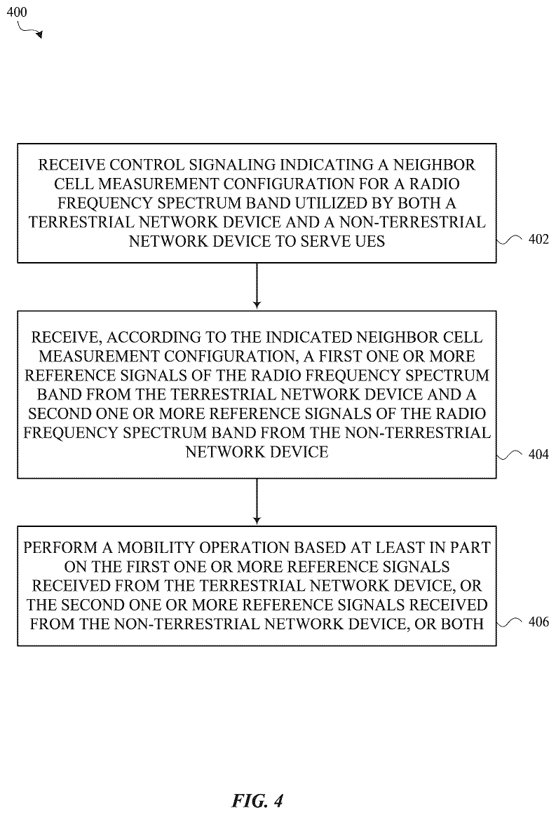

FIG. 4 shows an example method 400 of wireless communication at a UE, according to one or more aspects described herein. Method 400 supports one or more aspects of measurement capability and configuration on shared spectrum TN and NTN, as further described herein. In some cases, the UE may be the UE 102, or one of the other UEs described herein. The method 400 may be performed using a processor, a main radio (or transceiver), or other components of the UE.

At 402, the method 400 includes receiving control signaling indicating a neighbor cell measurement configuration for a RF spectrum band utilized by both a terrestrial network device and a non-terrestrial network device to serve UEs.

At 404, the method 400 includes receiving, according to the indicated neighbor cell measurement configuration, a first one or more reference signals of the RF spectrum band from the terrestrial network device and a second one or more reference signals of the RF spectrum band from the non-terrestrial network device.

At 406, the method 400 includes performing a mobility operation based at least in part on the first one or more reference signals received from the terrestrial network device, or the second one or more reference signals received from the non-terrestrial network device, or both.

In some embodiments, the control signaling includes an information element that indicates that the RF spectrum band is configured for terrestrial measurements, or non-terrestrial measurements, or both.

In some embodiments, the control signaling includes a first information element for terrestrial measurements that identifies the RF spectrum band for measurement by the UE and a second information element for non-terrestrial measurements that identifies the RF spectrum band for measurement by the UE.

In some embodiments, the neighbor cell measurement configuration is a SMTC indicating whether the SMTC is for terrestrial measurements, non-terrestrial measurements, or both.

In some embodiments, the neighbor cell measurement configuration is a first SMTC for terrestrial measurements and a second SMTC for non-terrestrial measurements. In some embodiments, the method 400 further includes identifying whether the UE is in a terrestrial network coverage area, and prioritizing, based at least in part on identifying that the UE is in the terrestrial network coverage area, the first SMTC for the terrestrial measurements over the second SMTC for the non-terrestrial measurements. In other embodiments, the method 400 further includes identifying whether the UE is in a terrestrial network coverage area, and prioritizing, based at least in part on identifying that the UE is outside the terrestrial network coverage area or in a non-terrestrial network coverage area, the second SMTC for the non-terrestrial measurements over the first SMTC for the terrestrial measurements.

In some embodiments, the method 400 further includes transmitting capability signaling indicating that the UE supports non-terrestrial network SSB-based RRM measurements, and indicating whether the capability is for non-terrestrial measurements, terrestrial measurements, or both. In some embodiments, the capability signaling further indicates a quantity of SMTCs supported by the UE.

In some embodiments, the method 400 further includes transmitting capability signaling indicating that the UE supports non-terrestrial network SSB-based RRM measurements, and indicating a total quantity of SMTCs supported by the UE for both non-terrestrial measurements and terrestrial measurements.

In some embodiments, the method 400 further includes identifying whether a first time duration for terrestrial measurements overlaps with a second time duration for non-terrestrial measurements according to the neighbor cell measurement configuration, and prioritizing, based at least in part on identifying that the first time duration for terrestrial measurements overlaps with the second time duration for non-terrestrial measurements according to the neighbor cell measurement configuration, the terrestrial measurements of the first time duration over the non-terrestrial measurements of the second time duration.

In some embodiments, the method 400 further includes identifying whether a first time duration for terrestrial measurements overlaps with a second time duration for non-terrestrial measurements according to the neighbor cell measurement configuration, and prioritizing, based at least in part on identifying that the first time duration for terrestrial measurements overlaps with the second time duration for non-terrestrial measurements according to the neighbor cell measurement configuration, the non-terrestrial measurements of the second time duration over the terrestrial measurements of the first time duration

In some embodiments, the method 400 further includes receiving, via the transceiver, an indication of whether the UE is to prioritize terrestrial measurements of a first time duration or non-terrestrial measurements of a second time duration if the first time duration overlaps at least a portion of the second time duration.

In some embodiments, the method 400 further includes identifying that a first time duration for terrestrial measurements overlaps with a second time duration for non-terrestrial measurements according to the neighbor cell measurement configuration. In some embodiments, the method 400 further includes using at least a portion of instances of the first time duration for the terrestrial measurements and at least a portion of instances of the second time duration for the non-terrestrial measurements

The method 400 may be variously embodied, extended, or adapted, as described in the following paragraphs and elsewhere in this description,

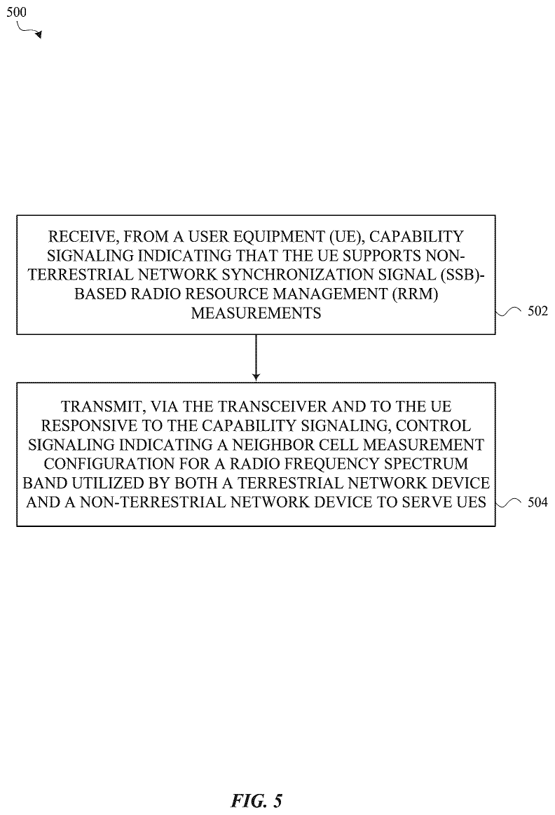

FIG. 5 shows an example method 500 of wireless communication at a network device, according to one or more aspects described herein. In some cases, the network entity may be the TN device 106, the NTN device 108, or one of the other network entities described herein. The method 500 may be performed using a processor, a main radio (or transceiver), or other components of the network entity.

At 502, the method 500 includes receiving, from a UE, capability signaling indicating that the UE supports NTN SSB-based RRM measurements.

At 504, the method 500 includes transmitting, to the UE responsive to the capability signaling, control signaling indicating a neighbor cell measurement configuration for a RF spectrum band utilized by both a TN device and an NTN device to serve UEs.

In some embodiments, the control signaling includes an information element that indicates that the RF spectrum band is configured for terrestrial measurements, or non-terrestrial measurements, or both.

In some embodiments, the control signaling includes a first information element for terrestrial measurements that identifies the RF spectrum band for measurement by the UE and a second information element for non-terrestrial measurements that identifies the RF spectrum band for measurement by the UE.

In some embodiments, the method 500 further includes transmitting, based at least in part on identifying that the non-terrestrial network device is within a threshold distance of the terrestrial network device, a request for the non-terrestrial network device to cease transmitting on the RF spectrum band that is utilized by both the terrestrial network device and the non-terrestrial network device.

In some embodiments, the method 500 further includes transmitting, based at least in part on identifying that a first coverage area of the non-terrestrial network device is within a threshold distance of a second coverage area of the terrestrial network device, a request for the non-terrestrial network device to cease transmitting on the RF spectrum band that is utilized by both the terrestrial network device and the non-terrestrial network device.

The method 500 may be variously embodied, extended, or adapted, as described in the following paragraphs and elsewhere in this description.

Embodiments contemplated herein include one or more non-transitory computer-readable media storing instructions to cause an electronic device, upon execution of the instructions by one or more processors of the electronic device, to perform one or more elements of the method 400 or 500. In the context of method 400, this non-transitory computer-readable media may be, for example, a memory of a UE (such as a memory 706 of a wireless device 702 that is a UE, as described herein). In the context of method 500, this non-transitory computer-readable media may be, for example, a memory of a network device (such as a memory 724 of a network device 720, as described herein).

Embodiments contemplated herein include an apparatus having logic, modules, or circuitry to perform one or more elements of the method 400 or 500. In the context of method 400, this apparatus may be, for example, an apparatus of a UE (such as a wireless device 702 that is a UE). In the context of method 500, this apparatus may be, for example, an apparatus of a network device (such as a network device 720, as described herein).

Embodiments contemplated herein include an apparatus having one or more processors and one or more computer-readable media, using or storing instructions that, when executed by the one or more processors, cause the one or more processors to perform one or more elements of the method 400 or 500. In the context of method 400, this apparatus may be, for example, an apparatus of a UE (such as a wireless device 702 that is a UE, as described herein). In the context of the method 500, this apparatus may be, for example, an apparatus of a network device (such as a network device 720, as described herein).

Embodiments contemplated herein include a signal as described in or related to one or more elements of the method 400 or 500.

Embodiments contemplated herein include a computer program or computer program product having instructions, wherein execution of the program by a processor causes the processor to carry out one or more elements of the method 400 or 500. In the context of method 400, the processor may be a processor of a UE (such as a processor(s) 704 of a wireless device 702 that is a UE, as described herein), and the instructions may be, for example, located in the processor and/or on a memory of the UE (such as a memory 706 of a wireless device 702 that is a UE, as described herein). In the context of method 500, the processor may be a processor of a network device (such as a processor(s) 722 of a network device 720, as described herein), and the instructions may be, for example, located in the processor and/or on a memory of the network device (such as a memory 724 of a network device 720, as described herein).

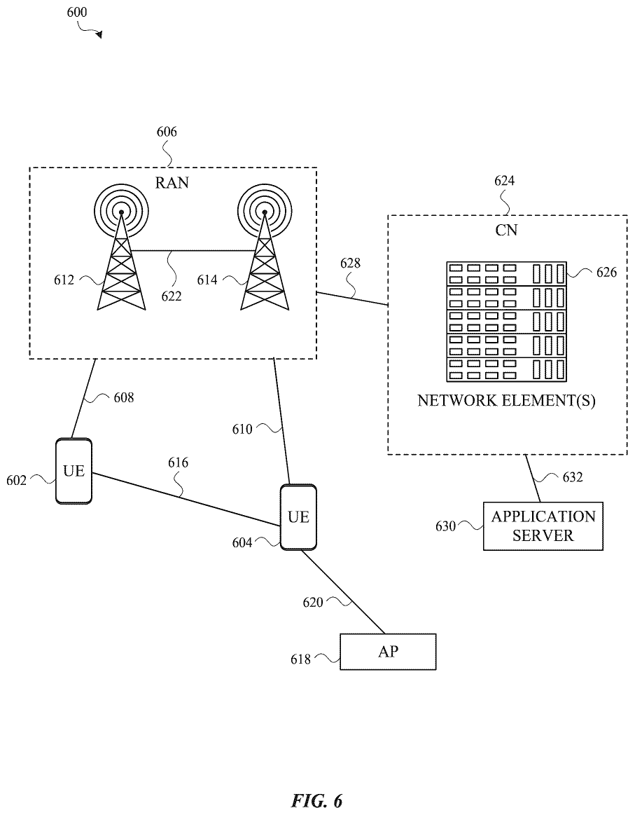

FIG. 6 illustrates an example architecture of a wireless communication system, according to embodiments described herein. The following description is provided for an example wireless communication system 600 that operates in conjunction with the LTE system standards or specifications and/or 5G or NR system standards or specifications, as provided by 3GPP technical specifications.

As shown by FIG. 6, the wireless communication system 600 includes UE 602 and UE 604 (although any number of UEs may be used). In this example, the UE 602 and the UE 604 are illustrated as smartphones (e.g., handheld touchscreen mobile computing devices connectable to one or more cellular networks) but may also comprise any mobile or non-mobile computing device configured for wireless communication.

The UE 602 and UE 604 may be configured to communicatively couple with a RAN 606. In embodiments, the RAN 606 may be NG-RAN, E-UTRAN, etc. The UE 602 and UE 604 utilize connections (or channels) (shown as connection 608 and connection 610, respectively) with the RAN 606, each of which comprises a physical communications interface. The RAN 606 can include one or more network devices, such as base station 612 and base station 614, that enable the connection 608 and connection 610.

In this example, the connection 608 and connection 610 are air interfaces to enable such communicative coupling and may be consistent with RAT(s) used by the RAN 606, such as, for example, an LTE and/or NR.

In some embodiments, the UE 602 and UE 604 may also directly exchange communication data via a sidelink interface 616. The UE 604 is shown to be configured to access an access point (shown as AP 618) via connection 620. By way of example, the connection 620 can comprise a local wireless connection, such as a connection consistent with any IEEE 802.11 protocol, wherein the AP 618 may comprise a Wi-Fi® router. In this example, the AP 618 may be connected to another network (for example, the Internet) without going through a CN 624.

In embodiments, the UE 602 and UE 604 can be configured to communicate using orthogonal frequency division multiplexing (OFDM) communication signals with each other or with the base station 612 and/or the base station 614 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 612 or base station 614 may be implemented as one or more software entities running on server computers as part of a virtual network. In addition, or in other embodiments, the base station 612 or base station 614 may be configured to communicate with one another via interface 622. In embodiments where the wireless communication system 600 is an LTE system (e.g., when the CN 624 is an EPC), the interface 622 may be an X2 interface. The X2 interface may be defined between two or more network devices of a RAN (e.g., two or more eNBs and the like) that connect to an EPC, and/or between two eNBs connecting to the EPC. In embodiments where the wireless communication system 600 is an NR system (e.g., when CN 624 is a 5GC), the interface 622 may be an Xn interface. The Xn interface is defined between two or more network devices of a RAN (e.g., two or more gNBs and the like) that connect to the 5GC, between a base station 612 (e.g., a gNB) connecting to the 5GC and an eNB, and/or between two eNBs connecting to the 5GC (e.g., CN 624).

The RAN 606 is shown to be communicatively coupled to the CN 624. The CN 624 may comprise one or more network elements 626, which are configured to offer various data and telecommunications services to customers/subscribers (e.g., users of UE 602 and UE 604) who are connected to the CN 624 via the RAN 606. The components of the CN 624 may be implemented in one physical device or separate physical devices including components to read and execute instructions from a machine-readable or computer-readable medium (e.g., a non-transitory machine-readable storage medium).

In embodiments, the CN 624 may be an EPC, and the RAN 606 may be connected with the CN 624 via an S1 interface 628. In embodiments, the S1 interface 628 may be split into two parts, an S1 user plane (S1-U) interface, which carries traffic data between the base station 612 or base station 614 and a serving gateway (S-GW), and the S1-MME interface, which is a signaling interface between the base station 612 or base station 614 and mobility management entities (MMEs).

In embodiments, the CN 624 may be a 5GC, and the RAN 606 may be connected with the CN 624 via an NG interface 628. In embodiments, the NG interface 628 may be split into two parts, an NG user plane (NG-U) interface, which carries traffic data between the base station 612 or base station 614 and a user plane function (UPF), and the S1 control plane (NG-C) interface, which is a signaling interface between the base station 612 or base station 614 and access and mobility management functions (AMFs).

Generally, an application server 630 may be an element offering applications that use internet protocol (IP) bearer resources with the CN 624 (e.g., packet switched data services). The application server 630 can also be configured to support one or more communication services (e.g., VoIP sessions, group communication sessions, etc.) for the UE 602 and UE 604 via the CN 624. The application server 630 may communicate with the CN 624 through an IP communications interface 632.

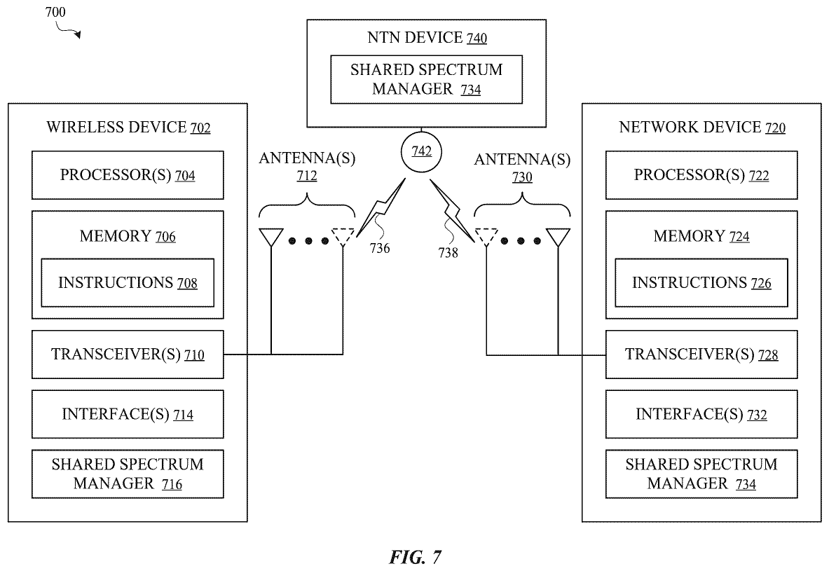

FIG. 7 illustrates an example system 700 for performing the signaling 738 between a wireless device 702 and a network device 720, according to embodiments described herein. The system 700 may be a portion of a wireless communication system as herein described. The wireless device 702 may be, for example, a UE of a wireless communication system. The network device 720 may be, for example, a base station (e.g., an eNB or a gNB) or a radio head of a wireless communication system.

The wireless device 702 may include one or more processor(s) 704. The processor(s) 704 may execute instructions such that various operations of the wireless device 702 are performed, as described herein. The processor(s) 704 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 702 may include a memory 706. The memory 706 may be a non-transitory computer-readable storage medium that stores the instructions 708 (which may include, for example, the instructions being executed by the processor(s) 704). The instructions 708 may also be referred to as program code or a computer program. The memory 706 may also store data used by, and results computed by, the processor(s) 704.

The wireless device 702 may include one or more transceiver(s) 710 (also collectively referred to as a transceiver 710) that may include RF (RF) transmitter and/or receiver circuitry that use the antenna(s) 712 of the wireless device 702 to facilitate signaling (e.g., the signaling 738) to and/or from the wireless device 702 with other devices (e.g., the network device 720) according to corresponding RATs.

The wireless device 702 may include one or more antenna(s) 712 (e.g., one, two, four, eight, or more). For embodiments with multiple antenna(s) 712, the wireless device 702 may leverage the spatial diversity of such multiple antenna(s) 712 to send and/or receive multiple different data streams on the same time and frequency resources. This behavior may be referred to as, for example, MIMO behavior (referring to the multiple antennas used at each of a transmitting device and a receiving device that enable this aspect), MIMO transmissions by the wireless device 702 may be accomplished according to precoding (or digital beamforming) that is applied at the wireless device 702 that multiplexes the data streams across the antenna(s) 712 according to known or assumed channel characteristics such that each data stream is received with an appropriate signal strength relative to other streams and at a desired location in the spatial domain (e.g., the location of a receiver associated with that data stream). Some embodiments may use single user MIMO (SU-MIMO) methods (where the data streams are all directed to a single receiver) and/or multi-user MIMO (MU-MIMO) methods (where individual data streams may be directed to individual (different) receivers in different locations in the spatial domain).

In some embodiments having multiple antennas, the wireless device 702 may implement analog beamforming techniques, whereby phases of the signals sent by the antenna(s) 712 are relatively adjusted such that the (joint) transmission of the antenna(s) 712 can be directed (this is sometimes referred to as beam steering).

The wireless device 702 may include one or more interface(s) 714. The interface(s) 714 may be used to provide input to or output from the wireless device 702. For example, a wireless device 702 that is a UE may include interface(s) 714 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 710 and antenna(s) 712 already described) that allow for communication between the UE and other devices and may operate according to known protocols (e.g., Wi-Fi®, Bluetooth®, and the like).

The wireless device 702 may include shared spectrum manager 716. The shared spectrum manager 716 may be implemented via hardware, software, or combinations thereof. For example, the shared spectrum manager 716 may be implemented as a processor, circuit, and/or instructions 708 stored in the memory 706 and executed by the processor(s) 704. In some examples, the shared spectrum manager 716 may be integrated within the processor(s) 704 and/or the transceiver(s) 710. For example, the shared spectrum manager 716 may be implemented by a combination of software components (e.g., executed by a DSP or a general processor) and hardware components (e.g., logic gates and circuitry) within the processor(s) 704 or the transceiver(s) 710.

The shared spectrum manager 716 may be used for various aspects of the present disclosure, for example, aspects of FIGS. 1-7, from a wireless device or UE perspective. The shared spectrum manager 716 may be configured to, for example, cause the wireless device 702 to receive, via the transceiver 710, control signaling indicating a neighbor cell measurement configuration for a RF spectrum band utilized by both a terrestrial network device and a non-terrestrial network device to serve UEs. The shared spectrum manager 716 may be further configured to, for example, cause the wireless device 702 to receive, via the transceiver 710 and according to the indicated neighbor cell measurement configuration, a first one or more reference signals of the RF spectrum band from the terrestrial network device and a second one or more reference signals of the RF spectrum band from the non-terrestrial network device. The shared spectrum manager 716 may be further configured to, for example, cause the wireless device 702 to perform a mobility operation based at least in part on the first one or more reference signals received from the terrestrial network device, or the second one or more reference signals received from the non-terrestrial network device, or both.

The network device 720 may include one or more processor(s) 722. The processor(s) 722 may execute instructions such that various operations of the network device 720 are performed, as described herein. The processor(s) 722 may include one or more baseband processors implemented using, for example, a CPU, a DSP, an ASIC, a controller, an FPGA device, another hardware device, a firmware device, or any combination thereof configured to perform the operations described herein.

The network device 720 may include a memory 724. The memory 724 may be a non-transitory computer-readable storage medium that stores the instructions 726 (which may include, for example, the instructions being executed by the processor(s) 722). The instructions 726 may also be referred to as program code or a computer program. The memory 724 may also store data used by, and results computed by, the processor(s) 722.

The network device 720 may include one or more transceiver(s) 728 (also collectively referred to as a transceiver 728) that may include RF transmitter and/or receiver circuitry that use the antenna(s) 730 of the network device 720 to facilitate signaling (e.g., the signaling 738) to and/or from the network device 720 with other devices (e.g., the wireless device 702) according to corresponding RATs.

The network device 720 may include one or more antenna(s) 730 (e.g., one, two, four, or more). In embodiments having multiple antenna(s) 730, the network device 720 may perform MIMO, digital beamforming, analog beamforming, beam steering, etc., as has been described.

The network device 720 may include one or more interface(s) 732. The interface(s) 732 may be used to provide input to or output from the network device 720. For example, a network device 720 of a RAN (e.g., a base station, a radio head, etc.) may include interface(s) 732 made up of transmitters, receivers, and other circuitry (e.g., other than the transceiver(s) 728/antenna(s) 730 already described) that enables the network device 720 to communicate with other equipment in a network, and/or that enables the network device 720 to communicate with external networks, computers, databases, and the like for purposes of operations, administration, and maintenance of the network device 720 or other equipment operably connected thereto.

The network device 720 may include at least one shared spectrum manager 734. The shared spectrum manager 734 may be implemented via hardware, software, or combinations thereof. For example, the shared spectrum manager 734 may be implemented as a processor, circuit, and/or instructions 726 stored in the memory 724 and executed by the processor(s) 722. In some examples, the shared spectrum manager 734 may be integrated within the processor(s) 722 and/or the transceiver(s) 728. For example, the shared spectrum manager 734 may be implemented by a combination of software components (e.g., executed by a DSP or a general processor) and hardware components (e.g., logic gates and circuitry) within the processor(s) 722 or the transceiver(s) 728.

The shared spectrum manager 734 may be used for various aspects of the present disclosure, for example, aspects of FIGS. 1-7, from a network device perspective. The shared spectrum manager 734 may be configured to, for example, cause the network device 720 or the NTN device 740 to receive, from the wireless device 702 (e.g., directly or vian NTN device 740), capability signaling indicating that the wireless device 702 supports non-terrestrial network SSB-based RRM measurements. The shared spectrum manager 734 may be further configured to, for example, cause the network device 720 or the NTN device 740 to transmit, via the transceiver 728 and to the wireless device 702 (e.g., directly or vian NTN device 740) responsive to the capability signaling, control signaling indicating a neighbor cell measurement configuration for a RF spectrum band utilized by both a terrestrial network device and a non-terrestrial network device to serve UEs.

For one or more embodiments, at least one of the components set forth in one or more of the preceding figures may be configured to perform one or more operations, techniques, processes, and/or methods as set forth herein. For example, a baseband processor (or processor) as described herein in connection with one or more of the preceding figures may be configured to operate in accordance with one or more of the examples set forth herein. For another example, circuitry associated with a UE, network device, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description but is not intended to be exhaustive or to limit the scope of embodiments to the precise form described. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

The systems described herein pertain to specific embodiments but are provided as examples. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

Although the foregoing has been described in some detail for purposes of clarity, it will be apparent that changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein but may be modified within the scope and equivalents of the appended claims.

1. A user equipment (UE), comprising:
a transceiver; and
a processor configured to cause the UE to,
receive, via the transceiver, control signaling indicating a neighbor cell measurement configuration for a radio frequency spectrum band utilized by both a terrestrial network device and a non-terrestrial network device to serve UEs,
receive, via the transceiver and according to the indicated neighbor cell measurement configuration, a first one or more reference signals of the radio frequency spectrum band from the terrestrial network device and a second one or more reference signals of the radio frequency spectrum band from the non-terrestrial network device, and
perform a mobility operation based at least in part on the first one or more reference signals received from the terrestrial network device, or the second one or more reference signals received from the non-terrestrial network device, or both.

2. The UE of claim 1, wherein the control signaling comprises an information element that indicates that the radio frequency spectrum band is configured for terrestrial measurements, or non-terrestrial measurements, or both.

3. The UE of claim 1, wherein the control signaling comprises a first information element for terrestrial measurements that identifies the radio frequency spectrum band for measurement by the UE and a second information element for non-terrestrial measurements that identifies the radio frequency spectrum band for measurement by the UE.

4. The UE of claim 1, wherein the neighbor cell measurement configuration comprises a synchronization signal block (SSB)-based radio resource management (RRM) measurement timing configuration (SMTC) indicating whether the SMTC is for terrestrial measurements, non-terrestrial measurements, or both.

5. The UE of claim 1, wherein the neighbor cell measurement configuration comprises a first synchronization signal block (SSB)-based radio resource management (RRM) measurement timing configuration (SMTC) for terrestrial measurements and a second SMTC for non-terrestrial measurements.

6. The UE of claim 5, wherein the processor is further configured to:
identify whether the UE is in a terrestrial network coverage area; and
prioritize, based at least in part on identifying that the UE is in a terrestrial network coverage area, the first SMTC for the terrestrial measurements over the second SMTC for the non-terrestrial measurements; or
prioritize, based at least in part on identifying that the UE is outside the terrestrial network coverage area or in a non-terrestrial network coverage area, the second SMTC for the non-terrestrial measurements over the first SMTC for the terrestrial measurements.

7. The UE of claim 1, wherein the processor is further configured to:
transmit, via the transceiver, capability signaling indicating that the UE supports non-terrestrial network synchronization signal (SSB)-based radio resource management (RRM) measurements, and indicating whether the capability is for non-terrestrial measurements, terrestrial measurements, or both.

8. The UE of claim 7, wherein the capability signaling further indicates a quantity of SSB-based RRM measurement timing configuration (SMTC) supported by the UE.

9. The UE of claim 1, wherein the processor is further configured to:
transmit, via the transceiver, capability signaling indicating that the UE supports non-terrestrial network synchronization signal (SSB)-based radio resource management (RRM) measurements, and indicating a total quantity of SSB-based RRM measurement timing configuration (SMTC) supported by the UE for both non-terrestrial measurements and terrestrial measurements.

10. The UE of claim 1, wherein the processor is further configured to:
identify whether a first time duration for terrestrial measurements overlaps with a second time duration for non-terrestrial measurements according to the neighbor cell measurement configuration; and
prioritize, based at least in part on identifying that the first time duration for terrestrial measurements overlaps with the second time duration for non-terrestrial measurements according to the neighbor cell measurement configuration, the terrestrial measurements of the first time duration over the non-terrestrial measurements of the second time duration; or
prioritize, based at least in part on identifying that the first time duration for terrestrial measurements overlaps with the second time duration for non-terrestrial measurements according to the neighbor cell measurement configuration, the non-terrestrial measurements of the second time duration over the terrestrial measurements of the first time duration.

11. The UE of claim 1, wherein the processor is further configured to:
receive, via the transceiver, an indication of whether the UE is to prioritize terrestrial measurements of a first time duration or non-terrestrial measurements of a second time duration if the first time duration overlaps at least a portion of the second time duration.

12. The UE of claim 1, wherein the processor is further configured to:
identify that a first time duration for terrestrial measurements overlaps with a second time duration for non-terrestrial measurements according to the neighbor cell measurement configuration; and
use at least a portion of instances of the first time duration for the terrestrial measurements and at least a portion of instances of the second time duration for the non-terrestrial measurements.

13. A network device, comprising:
a transceiver; and
a processor configured to cause the network device to,
receive, from a user equipment (UE), capability signaling indicating that the UE supports non-terrestrial network synchronization signal (SSB)-based radio resource management (RRM) measurements, and
transmit, via the transceiver and to the UE responsive to the capability signaling, control signaling indicating a neighbor cell measurement configuration for a radio frequency spectrum band utilized by both a terrestrial network device and a non-terrestrial network device to serve UEs.

14. The UE of claim 13, wherein the processor is further configured to cause the network device to:
transmit, via the transceiver and based at least in part on identifying that the non-terrestrial network device is within a threshold distance of the terrestrial network device, a request for the non-terrestrial network device to cease transmitting on the radio frequency spectrum band that is utilized by both the terrestrial network device and the non-terrestrial network device.

15. The UE of claim 13, wherein the processor is further configured to cause the network device to:
transmit, via the transceiver and based at least in part on identifying that a first coverage area of the non-terrestrial network device is within a threshold distance of a second coverage area of the terrestrial network device, a request for the non-terrestrial network device to cease transmitting on the radio frequency spectrum band that is utilized by both the terrestrial network device and the non-terrestrial network device.

16. The UE of claim 13, wherein the control signaling comprises an information element that indicates that the radio frequency spectrum band is configured for terrestrial measurements, or non-terrestrial measurements, or both.

17. The UE of claim 13, wherein the control signaling comprises a first information element for terrestrial measurements that identifies the radio frequency spectrum band for measurement by the UE and a second information element for non-terrestrial measurements that identifies the radio frequency spectrum band for measurement by the UE.

18. A method of wireless communication at a user equipment (UE), comprising:
receiving control signaling indicating a neighbor cell measurement configuration for a radio frequency spectrum band utilized by both a terrestrial network device and a non-terrestrial network device to serve UEs;
receiving, according to the indicated neighbor cell measurement configuration, a first one or more reference signals of the radio frequency spectrum band from the terrestrial network device and a second one or more reference signals of the radio frequency spectrum band from the non-terrestrial network device; and
performing a mobility operation based at least in part on the first one or more reference signals received from the terrestrial network device, or the second one or more reference signals received from the non-terrestrial network device, or both.
